(19) United States
(12) Patent Application Publication
(10) Pub. No.: US 2002/0187917 A1
(43) Pub. Date: Dec. 12, 2002

(54) High-foaming non-anionic surfactant compositions

(76) Inventor: Virginia Lazarowitz, Hatfield, PA (US)

Correspondence Address: COGNIS CORPORATION, 2500 RENAISSANCE BLVD., SUITE 200, GULPH MILLS, PA, 19406

(21) Appl. No.: 10/124,447

(22) Filed: Apr. 17, 2002

Related U.S. Application Data
(60) Provisional application No. 60/290,857, filed on May 14, 2001.

(51) Int. Cl. C11D 1/00

(52) U.S. Cl. 510/470; 510/490; 510/499

(57) ABSTRACT

A surfactant composition containing: (a) from at least about 0.1 to at most about 50% by weight of an alkyl polyglycoside corresponding to formula (I):

R₁O(Z)ₐ (I)

wherein R₁ is a monovalent organic radical having from about 8 to about 16 carbon atoms; Z is a saccharide residue having 5 or 6 carbon atoms; a is a number having a value of from about 1.4 to about 1.6; and (b) from at least about 0.1 to at most about 30% by weight of a co-surfactant selected from the group consisting of a betaine, an amphoacetate, a primary alkyl amine and/or its salt derivative, and mixtures thereof, all weights being based on the total weight of the composition, and wherein the composition is free of anionic surfactants.

### CROSS-REFERENCE TO RELATED APPLICATIONS

This application claims priority of U.S. Provisional Application Serial No. 60/290,857 filed on May 14, 2001.

### STATEMENT REGARDING FEDERALLY SPONSORED RESEARCH OR DEVELOPMENT

Not applicable.

### BACKGROUND OF THE INVENTION

The present invention generally relates to surfactant compositions which provide exceptional degrees of foaming in the absence of any anionic surfactants being present in the composition.

It is known that various surfactants have been found to be useful in cleaning compositions, such as shower gels, shampoos, and light duty detergents such as dish washing detergents. In these types of compositions, good foamability is a prerequisite. The most widely used surfactants in these types of compositions, due to their exceptional ability at generating foam, are anionic surfactants such as alkyl sulfates, alkyl ether sulfates, sulfonates, sulfosuccinates and sarcosinates.

Although the use of anionic surfactants in these types of compositions permits the attainment of desirable properties, including good foamability, their skin mildness profile leaves much to be desired. Anionic surfactants, per se, are harsh on human skin. As a result, compositions such as those identified above may require the use of large amounts of emollients to be incorporated therein in order to protect the skin from the harsh side-effects of the anionic surfactants.

It is therefore an object of the present invention to provide a surfactant composition having both high foaming and improved skin mildness profiles.

### BRIEF SUMMARY OF THE INVENTION

The present invention is directed to a surfactant composition capable of both a high degree of foaming and imparting enhanced mildness onto human skin, the composition containing:

(a) from at least about 0.1% by weight, to at most about 50% by weight of an alkyl polyglycoside corresponding to formula I:

R₁O(Z)ₐ (I)

wherein R₁ is a monovalent organic radical having from about 8 to about 16 carbon atoms; Z is a saccharide residue having 5 or 6 carbon atoms; a is a number having a value of from about 1.4 to about 1.6; and

(b) from at least about 0.1% by weight, to at most about 70% by weight of a co-surfactant selected from the group consisting of a betaine, an amphoacetate, a primary alkyl amine and/or its salt derivative, and mixtures thereof.

The present invention is also directed to a process for making a surfactant composition capable of generating high levels of foam while at the same time imparting a high degree of mildness onto human skin, in the absence of any anionic surfactants being incorporated therein, the process involving:

(a) providing from at least about 0.1% by weight, to at most about 50% by weight of an alkylpolyglycoside corresponding to formula I:

R₁O(Z)ₐ (I)

wherein R₁ is a monovalent organic radical having from about 8 to about 16 carbon atoms; Z is a saccharide residue having 5 or 6 carbon atoms; a is a number having a value of from about 1.4 to about 1.6;

(b) providing from at least about 0.1% by weight, to at most about 30% by weight of a co-surfactant selected from the group consisting of a betaine, an amphoacetate, a primary alkyl amine and/or its salt derivative, and mixtures thereof; and

(c) mixing (a) and (b) to form the surfactant mixture.

### DETAILED DESCRIPTION OF THE INVENTION

Other than in the operating examples, or where otherwise indicated, all numbers expressing quantities of ingredients and/or reaction conditions are to be understood as being modified in all instances by the term “about”.

The present invention is based on the surprising discovery that a surfactant composition capable of generating exceptional levels of foaming and having improved mildness properties on human skin can be formulated without using anionic surfactants. By combining an alkyl polyglycoside with a co-surfactant selected from the group consisting of a betaine, a primary alkyl amine salt, an amphoacetate, and mixtures thereof, a surfactant composition having the above-described properties can be formulated in the absence of any anionic surfactants being present therein.

The alkyl polyglycosides employed by the present invention are those corresponding to formula I:

R₁O(Z)ₐ (I)

wherein R₁ is a monovalent organic radical having from about 8 to about 16 carbon atoms; Z is a saccharide residue having 5 or 6 carbon atoms; a is a number having a value of about 1.6. These alkyl polyglucosides, which are made by reacting a mixture of fatty alcohols having 8 to 16 carbon atoms and glucose and are available commercially, for example, from Cognis Corporation under the tradenames GLUCOPON® 425, 600 and 625.

GLUCOPON® 425 is an alkyl polyglycoside with an alkyl group containing from 8 to 16 carbon atoms and having an average degree of polymerization of 1.6. GLUCOPON® 600 is an alkyl polyglycoside with an alkyl group containing from 12 to 16 carbon atoms and having an average degree of polymerization of 1.4. GLUCOPON® 625 is an alkyl polyglycoside with an alkyl group containing from 12 to 16 carbon atoms and having an average degree of polymerization of 1.6.

The alkyl polyglycoside will typically be present in the surfactant composition in the following order of preference: at least about 0.1% by weight; at least about 1% by weight; at least about 5% by weight; at least about 10% by weight; at least about 15% by weight; at least about 20% by weight; at least about 25% by weight; at least about 30% by weight; at least about 35% by weight; at least about 40% by weight; at least about 45% by weight; and a most about 50% by weight, all weights being based on the total weight of the composition.

In a particularly preferred embodiment, the alkyl polyglycoside is present in the composition in an amount of from about 5 to about 20% by weight, based on the weight of the composition.

The co-surfactants employed in the present invention are, in general, those selected from the group consisting of a betaine, an amphoacetate, a primary alkyl amine, and mixtures thereof.

Suitable betaines for use in the present invention include, for example, those corresponding to formulas (II) and (IIA):

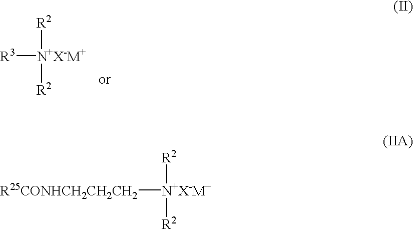

wherein R³ is a C₈₋₂₂ straight or branched chain, saturated or unsaturated aliphatic radical, R² is methyl or 2-hydroxy ethyl, X⁻ is CH₂COO⁻ or CH₂CH(OH)CH₂SO₃⁻, and M⁺ is Na, K or ammonium.

Specific examples thereof include, but are not limited to, ricinoleamidopropyl betaine, cocamidopropyl betaine, stearyl betaine, lauric myristic betaine, cocoamidosulfobetaine, alkylamidophospho betaine, alkyldimethylbetaines in which the alkyl group contains 8-18 carbon atoms, and the like. A particularly preferred betaine is cocoamidopropyl betaine.

In the event that a betaine is chosen as the co-surfactant component, it will typically be present in the surfactant composition in consecutively preferred amounts of at least about 0.1% by weight; at least about 1% by weight; at least about 2% by weight, at least about 3% by weight; at least about 5% by weight, at least about 7% by weight, at least about 10% by weight , at least about 15% by weight, at least about 20% by weight, at least about 25% by weight, at most about 30% by weight, all weights being based on the total weight of the composition.

Examples of suitable amphoacetates which may be employed in the present invention include, but are not limited to, cocoamphocarboxypropionates, cocoamphoglycinates, cocoamphopropionates, lauroamphocarboxypropionates, lauroamphocarboxyglycinates, lauroamphocarboxypropionic acid, and lauroamphoglycinates.

In the event that an amphoacetate is chosen as the co-surfactant component, it will typically be present in the surfactant composition in consecutively preferred amounts of at least about 0.1% by weight; at least about 1% by weight; at least about 2% by weight, at least about 3% by weight; at least about 5% by weight, at least about 7% by weight, at least about 10% by weight, at least about 15% by weight, at least about 20% by weight, at least about 25% by weight, at most about 30% by weight, all weights being based on the total weight of the composition.

Suitable primary alkyl amines which may be employed by the present invention include those corresponding to formula III:

R⁴—NH₂ (III)

wherein R⁴ is an alkyl group having from about 6 to about 18 carbon atoms, and preferably from about 12-14 carbon atoms.

Similarly, primary alkyl amine salt derivatives which may be employed in the present invention are those corresponding to formula IIIA:

R⁴—N+H₃—X⁻—M (IIIA)

wherein R⁴ is a branched or linear alkyl group having from about 6 to about 18 carbon atoms, X is an acid group and M is a salt-forming cation or hydrogen.

The components used to make the primary alkyl amine salts include: water, a salt, a strong acid and the primary alkyl amine of formula (III). Suitable acids which may be employed include, for example, phosphoric, hydrochloric and sulfuric acids.

A particularly preferred primary alkyl amine for use in the present invention is one corresponding to formula (III) wherein R⁴ is an alkyl group having from about 12 to about 14 carbon atoms.

In the event that a primary alkyl amine is chosen as the co-surfactant component, it will typically be present in the surfactant composition in consecutively preferred amounts of at least about 0.1% by weight; at least about 1% by weight; at least about 2% by weight; at least about 3% by weight; at least about 5% by weight; at least about 7% by weight; at least about 10% by weight; at least about 15% by weight; at least about 20% by weight; at least about 25% by weight; at most about 30% by weight; all weights being based on the total weight of the composition.

In a particularly preferred embodiment, the co-surfactant is present in the composition in an amount of from about 1 to about 10% by weight, and most preferably from about 2 to about 7% by weight, based on the weight of the composition.

According to one embodiment of the present invention there is provided a surfactant composition capable of a high degree of foaming and which is mild to human skin. The composition contains, in consecutively preferred amounts of: (a) at least about 0.1% by weight; at least about 1% by weight; at least about 5% by weight; at least about 10% by weight; at least about 15% by weight; at least about 20% by weight; at least about 25% by weight; at least about 30% by weight; at least about 35% by weight; at least about 40% by weight; at least about 45% by weight; and a most about 50% by weight; of an alkyl polyglycoside corresponding to formula I; and (b) at least about 0.1% by weight; at least about 1% by weight; at least about 2% by weight, at least about 3% by weight; at least about 5% by weight , at least about 7% by weight, at least about 10% by weight , at least about 15% by weight, at least about 20% by weight, at least about 25% by weight, at most about 30% by weight, of a co-surfactant component, all weights being based on the total weight of the composition.

The surfactant composition, due to its exceptionally high foaming profile, is preferably free of anionic surfactants.

The present invention is also directed to a process for making a surfactant composition, preferably free of anionic surfactants, capable of high foaming and imparting mildness onto human skin, the process involving mixing the above-identified components.

Commercial applications for the surfactant composition of the present invention include, in general, any products used for cleaning which require a high degree of foam generation and are mild when in contact with human skin such as, for example, a dishwashing detergent. Particularly preferred uses, however, are in personal cleansing products such as body soaps, shampoos, and the like. The exact amount of surfactant composition used to formulate a cleaning product will of course depend on the specific product's intended use. In general, however, the surfactant composition will be employed in cleaning compositions in consecutively preferred amounts of at least about 1% by weight; at least about 5% by weight; at least about 10% by weight; at least about 15% by weight; at least about 20% by weight; at least about 25% by weight; at least about 30% by weight; at least about 35% by weight; at least about 40% by weight; at least about 45% weight; at least about 50% by weight; all weights being based on the total weight of the personal cleaning composition.

The present invention will be better understood from the examples which follow, all of which are intended for illustrative purposes only and are not meant to unduly limit the scope of the invention in any way.

### EXAMPLES

Foam produced in a shampoo or body wash is made in a high shear environment. For this reason foam in the laboratory is also tested under high shear conditions using a Waring Blender. Foam is evaluated using 4 grams of product in 146 grams of water, blending at high speed for 10 seconds, then transferring the foam and water to a graduated cylinder to read the foam heights. To see the effect of sebum on foam the test is repeated adding 0.5 grams of artificial sebum to the water surfactant mixture. Test formulations were prepared by combining 15% Active PLANTAREN 2000® with a co-surfactant component. The specific formulations and test results are found below.

| Co-surfactant Component | Without Sebum | With Sebum |
|---|---|---|
| (a) 5% active cocamidopropyl | 640 mls of foam | 240 mls of foam |
| betaine | | |
| (b) 5% active monoethanolamide | 500 mls of foam | 320 mls of foam |
| (c) 5% active cocoamphodiacetate | 620 mls of foam | 280 mls of foam |
| (d) 5% active sodium | 690 mls of foam | 380 mls of foam |
| lauriminodipropionate | | |

The above-disclosed formulations, free of anionic surfactants, compared favorably to commercial products containing anionic surfactants. The commercial products compared and test results are found below.

Commercial Anionic Containing Products

| | | |
|---|---|---|
| (A) BATH AND BODY-DAFFODIL BODY WASH ® | 630 mls of foam | 370 mls of foam |
| (B) LEVER 2000 ® | 600 mls of foam | 300 mls of foam |
| (C) DIAL SHOWER CREAM ® | 500 mls of foam | 240 mls of foam |
| (D) DOVE SENSITIVE SKIN ® | 420 mls of foam | 260 mls of foam |

What is claimed is:

1. A surfactant composition comprising:
(a) from at least about 0.1 to at most about 50% by weight of an alkyl polyglycoside corresponding to formula (I):
R₁O(Z)ₐ (I)
wherein R₁ is a monovalent organic radical having from about 8 to about 16 carbon atoms; Z is a saccharide residue having 5 or 6 carbon atoms; a is a number having a value of from about 1.4 to about 1.6; and
(b) from at least about 0.1 to at most about 30% by weight of a co-surfactant selected from the group consisting of a betaine, an amphoacetate, a primary alkyl amine and/or its salt derivative, and mixtures thereof, all weights being based on the total weight of the composition, and wherein the composition is free of anionic surfactants.

2. The composition of claim 1 wherein the co-surfactant is a betaine.

3. The composition of claim 1 wherein the co-surfactant is an amphoacetate.

4. The composition of claim 1 wherein the co-surfactant is a primary alky amine and/or its salt derivative.

5. A cleaning formulation comprising from at least about 1 to at most about 50% by weight of a surfactant composition, based on the weight of the formulation, the surfactant composition containing:
(a) from at least about 0.1 to at most about 50% by weight of an alkyl polyglycoside corresponding to formula (I):
R₁O(Z)ₐ (I)
wherein R₁ is a monovalent organic radical having from about 8 to about 16 carbon atoms; Z is a saccharide residue having 5 or 6 carbon atoms; a is a number having a value of from about 1.4 to about 1.6; and
(b) from at least about 0.1 to at most about 30% by weight of a co-surfactant selected from the group consisting of a betaine, an amphoacetate, a primary alkyl amine and/or its salt derivative, and mixtures thereof, all weights being based on the total weight of the composition, and wherein the formulation is free of anionic surfactants.

6. The composition of claim 5 wherein the co-surfactant is a betaine.

7. The composition of claim 5 wherein the co-surfactant is an amphoacetate.

8. The composition of claim 5 wherein the co-surfactant is a primary alky amine and/or its salt derivative.

9. A process for enhancing the cleaning effectiveness of a cleaning formulation, free of anionic surfactants, comprising adding from at least about 1 to at most about 50% by weight, based on the weight of the formulation, of a surfactant composition, to the formulation, the surfactant composition containing:
(a) from at least about 0.1 to at most about 50% by weight of an alkyl polyglycoside corresponding to formula (I):
R₁O(Z)ₐ (I)
wherein R₁ is a monovalent organic radical having from about 8 to about 16 carbon atoms; Z is a saccharide residue having 5 or 6 carbon atoms; a is a number having a value of from about 1.4 to about 1.6; and
(b) from at least about 0.1 to at most about 30% by weight of a co-surfactant selected from the group consisting of a betaine, an amphoacetate, a primary alkyl amine and/or its salt derivative, and mixtures thereof, all weights being based on the total weight of the composition, and wherein the formulation is free of anionic surfactants.

10. The composition of claim 9 wherein the co-surfactant is a betaine.

11. The composition of claim 9 wherein the co-surfactant is an amphoacetate.

12. The composition of claim 9 wherein the co-surfactant is a primary alky amine and/or its salt derivative.
